(19) United States
(12) Patent Application Publication
(10) Pub. No.: US 2004/0041351 A1
(43) Pub. Date: Mar. 4, 2004

(54) Gap seal for sealing a gap between two adjacent components

(76) Inventors: Alexander Beeck, Orlando, FL (US); Arkadi Fokine, Moscow (RU); Igor Ossipov, Moscow (RU); Edouard Sloutski, Moscow (RU)

Correspondence Address: ADAM J. CERMAK, P.O. BOX 7518, ALEXANDRIA, VA, 22307-7518, US

(21) Appl. No.: 10/611,944

(22) Filed: Jul. 3, 2003

(30) Foreign Application Priority Data
Jul. 5, 2002 (RU) 2002118196
Jul. 3, 2002 (RU) 2002117875

(51) Int. Cl. F16J 15/54

(52) U.S. Cl. 277/503

(57) ABSTRACT

The invention relates to a gap seal (6)for sealing a gap (3) between two adjacent components (1,2), in particular in turbo machines. A sealing body (7) has a band (18) with a cross-section that is bent in such a way that two contact zones (8) formed on it abut with a preloan against two facing sealing surfaces (9) of components (1,2). The contact zones (8) are able to deflect resiliently when the distance between the sealing surfaces (9) is reduced. A support zone (11) formed between the contact zones (8) is supported on a step (10) vertically to the spring movement. The step (10) is formed on one of the components (2) and projects from its sealing surface (9) towards the sealing surface (9) of the other component (1).

### FIELD OF TECHNOLOGY

The invention relates to a gap seal for sealing a gap between two adjacent components, in particular in turbo machines.

### STATE OF THE ART

In turbo machines, for example turbines and compressors, often many separate, individual components are attached to a housing or rotor. These components are usually guide vanes or rotor vanes or heat shield elements. A gap through which two spaces communicate with each other hereby may be formed between adjacent components. One of these spaces is, for example, a turbine stage in which a hot gas is under a first pressure, while the other space is a cooling channel in which a cooling gas is present under a second pressure. Accordingly, the gap must be sealed in a gas-tight and pressure-tight manner in order to prevent, on the one hand, a gas exchange between the two spaces and, on the other hand, a drop in pressure in one of the spaces. Gap seals of the initially mentioned type are used for this purpose.

Especially in turbo machines, the sealing of a gap also presents the problem that the adjacent components, between which the gap to be sealed is formed, may change their relative position to each other, for example due to heat expansion effects. The change in the relative position between the two components results in a change of the gap geometry, however, which makes the sealing of the gap more difficult.

### DESCRIPTION OF THE INVENTION

The invention means to remedy this. The invention, as characterized in the claims, has the objective of disclosing an embodiment for a gap seal of the initially mentioned type, which also ensures a sufficient seal of the gap when the components between which the gap is formed change their relative position with respect to each other.

According to the invention, this objective is realized with a gap seal having the characteristics of claim 1. The secondary claims have advantageous embodiments as their subject.

The invention is based on the general thought of clamping a sealing body with a resilient profile between two facing sealing surfaces formed on the components. This design has the result that the sealing profile, due to its resilience, is able to follow adjustment movements of the two components relative to each other that increase or decrease the distance between the two sealing surfaces, so that a sufficient sealing effect can be ensured in a relatively wide adjustment range.

It is useful that a band, of which the sealing body is produced with the desired profile by way of corresponding bending processes, consists of a spring steel that is bent in the corresponding manner. This makes it possible to realize relatively high preload forces, with which the contact zones of the sealing body come to abut against the sealing surfaces.

It is furthermore provided that the sealing body is supported, vertically to the spring movement of its contact zones that abut in a sealing manner against the sealing surfaces, by way of a support zone located between its contact zones on a step that starts on one of the components and projects into the gap. This achieves a fixation of the sealing body that ensures, in the case of a relative adjustment of the two components parallel to the gap plane, that the sealing surface that is adjustable relative to the step is able to adjust along the adjoining contact zone of the sealing body without reducing the sealing effect.

If the gap connects two spaces that have a different pressure, the sealing body, according to a preferred embodiment, is supported on that side of the step that faces the space with the higher pressure. Accordingly, the step is then located in a section of the gap that communicates with the other space, in which is the lower pressure. This arrangement has the result that the higher pressure pushes the sealing body against the step, so that it is fixed to the step.

In an especially advantageous further development, the sealing body may have a hollow profile that is open on one side of its cross-section, whereby the sealing body is then positioned in the gap in such a way that the profile opening is facing the space with the higher pressure. As a result of this special design and arrangement of the sealing body, the higher pressure is in the hollow profile of the sealing body, so that the preload of the sealing profile is additionally increased.

It is useful that the two sealing surfaces of the components are constructed level and extend parallel to each other, whereby the two contact zones are located on a straight line that is vertical to the sealing surfaces. Because of this, a symmetry is obtained for the force transfer from the components to the sealing body with relative movements between components, which symmetry reduces the risk of a canting of the sealing body inside the gap.

According to one further development, the band from which the sealing body is formed may have contact bodies formed on it that are provided with the contact zones with which the sealing body abuts the sealing surfaces of the components. With this design, different materials can be used for the contact bodies and the band, which materials can be selected depending on the respective component function. For example, a highly elastic spring steel is used for the band, while the contact bodies can be produced from a relatively soft alloy in order to improve the sealing effect. It is also possible to produce the contact bodies from a relatively hard material in order to reduce abrasion effects during the relative adjustments.

Other important characteristics and advantages of the gap seal according to the invention are found in the secondary claims, the drawings, and related descriptions of the figures in reference to the drawings.

### BRIEF DESCRIPTION OF DRAWINGS

Preferred exemplary embodiments of the invention are shown in the drawings and are explained in more detail in the following description, whereby identical reference numbers refer to identical or functionally identical or similar characteristics. The schematic drawings show in:

FIG. 1 a sectional view of a gap seal in a first embodiment and with a first gap geometry,

FIG. 2 a view corresponding to FIG. 1, but for a second gap geometry,

FIG. 3 a view corresponding to FIG. 1, but for a second embodiment,

FIG. 4 a view corresponding to FIG. 1, but for a third embodiment, and

FIG. 5 a view corresponding to FIG. 1, but for a fourth embodiment.

### WAYS OF EXECUTING THE INVENTION

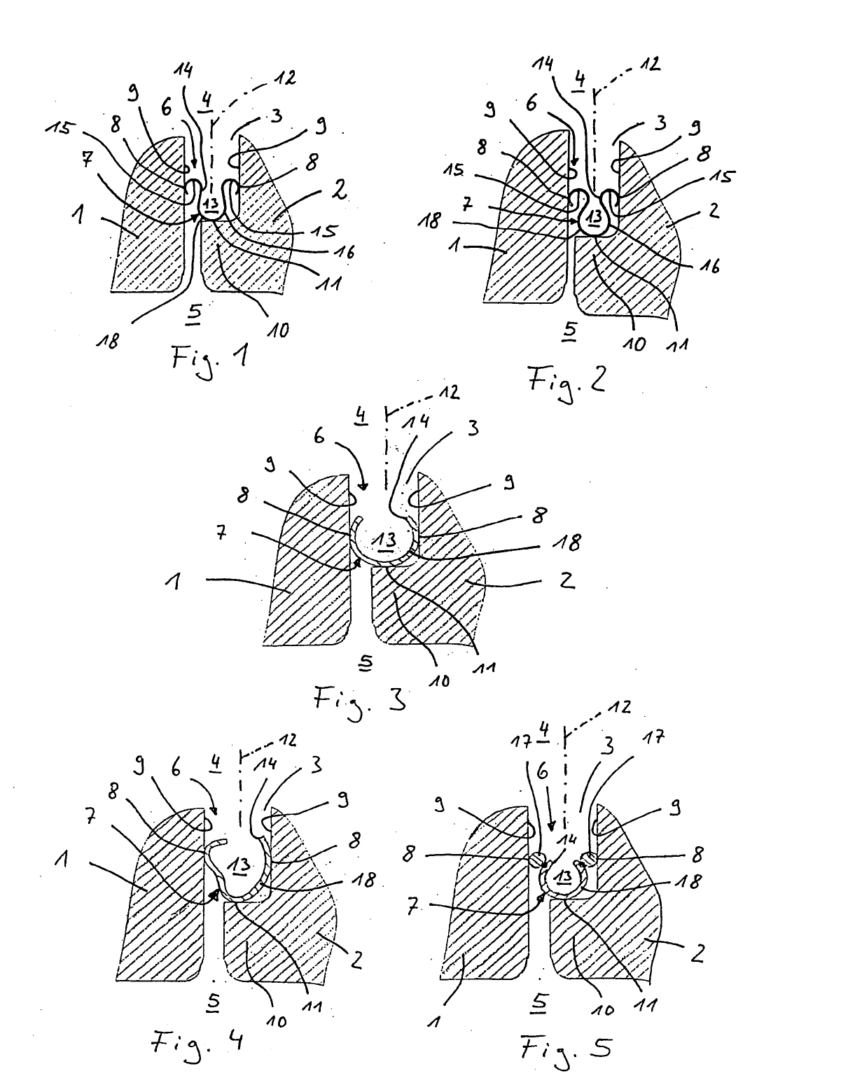

According to FIG. 1, a first component 1 (only partially shown) and a second component 2 (also only partially shown) are positioned on a body (not shown), for example a housing or rotor of a turbine or compressor, in such a way that they adjoin each other and form a gap 3 between them. The two components 1 and 2, for example, may be a heat shield element or a guide vane, or a rotor vane of a turbine or compressor.

At one end, the gap 3 leads to a first space 4, and at the other end to a second space 5. A gas exchange between these two spaces 4 and 5 is to be prevented. For this purpose, a gap seal 6 is positioned in the gap 3. According to the invention, this gap seal 6 comprises a sealing body 7 that is made from a bent band 18 or a band-shaped part. This band 18 is hereby shaped in such a way that the cross-section shown in the figures is obtained, which is also called the “sealing profile” from here on. The sealing body 7 has at its sealing profile two contact zones 8 that each abut against a sealing surface 9 of the components 1 and 2. These sealing surfaces 9 face each other inside the gap 3, and it is useful that they have a level construction and are arranged parallel to each other. The profile of the sealing body 7 now has been selected in such a way that the two contact zones 8 abut with a preload against the two sealing surfaces 9. The selected sealing profile furthermore ensures a resilient deflection of the two contact zones 8 when they are moved towards each other, for example by a corresponding movement of the two components 1 and 2. This means that with such relative movements between the components 1 and 2, the contact zones 8 are able to follow the sealing surfaces 9 so that they are able to ensure the sealing effect of the sealing body 7 even with these relative adjustments.

At one component, here at component 2, a step 10 is formed at the end of the gap 3 facing the second space 5, where said step projects away from the sealing surface 9 of this component 2 towards the other component 1 and hereby projects into the gap 3. On the side of step 10 facing away from the second room 5, the sealing body 7 is supported by means of a support zone 11 on this step 10 vertically to the previously described spring movement of the contact zones 8. The direction of this support therefore is parallel to a gap plane 12 that extends vertical to the drawing plane and stands, for example, vertical on a rotor axis of the turbine or the compressor.

According to the embodiments shown here, the sealing profile of the sealing body 7 is shaped so that the sealing body 7 has a hollow profile 13 that is open on one side of its cross-section, which hollow profile communicates via a profile opening 14 with the gap 3. In the case that different pressures exist in the two spaces 4 and 5, the step 10 is arranged in such a way that the sealing body 7 is supported on it on the side facing the space with the higher pressure. In the embodiments shown here, the first space 4 therefore has a higher pressure than the second space 5. It is useful that the sealing body 7 is then positioned in the gap 3 in such a way that the profile opening 14 faces the space with the higher pressure, i.e. in this case space 4, so that the higher pressure is also present in the hollow profile 13. This causes the outward directed preload force of the contact zones 8 to be increased by the pressure differential between spaces 4 and 5.

Because of the selected arrangement, the higher pressure of the first space 4 exerts a pressure force on the sealing body 7, said pressure force pushing it against the step 10, resulting in a sufficiently stable fixation or positioning of the sealing body 7 on the step 10. With a relative adjustment between the two components 1 and 2, during which one component moves parallel to the gap plane 12 relative to the other component, the sealing surface 9 of the first component 1 may be adjusted by sliding along the adjoining contact zone 8 without reducing the sealing effect. When the first component hereby, according to FIG. 2, moves upward relative to the step 10, the sealing body 7 remains in its position because the pressure differential between spaces 4 and 5 keeps the sealing body 7 preloaded downward against step 10, as shown in FIG. 2. During an opposite adjustment movement, i.e. where the first component 1 moves downward according to FIG. 2, the friction forces transferred to the sealing body 7 are directly supported via step 10.

With another relative adjustment, in which the two components 1 and 2 move relative to each other almost vertically to the gap plane 12, this results in an increase or decrease of the gap width, i.e. the (vertical) distance between the two sealing surfaces 9. If, according to FIG. 2, the two sealing surfaces 9 move towards each other, the gap width decreases, whereby the two contact surfaces 8 of the sealing body 7 also are moved towards each other. As a result of the sealing body's 7 profile according to the invention, the contact zones 8 hereby deflect resiliently. With an opposite adjustment movement, i.e. when the distance between the sealing surfaces 9 increases again, the contact zones 8 are able to follow the sealing surfaces 9, whereby a sufficient seal always can be ensured here also. It is clear that any desired combination of the two previously mentioned relative movements also may take place simultaneously.

It is useful that the shape of the sealing body 7 is chosen so that with a minimum distance between the two sealing surfaces 9, where the step 10 of the second component 2 comes to abut against the first component, and is still shaped by bending within the elastic range. As a result, the function of the gap seal 6 also can be ensured for extreme relative movements.

It is useful that the profiling of the sealing body 7 is selected so that the two contact zones 8 are on a straight line that extends vertical to the sealing surfaces 9 that extend parallel to each other. This results in a symmetry of the forces acting on the sealing body 7 during the relative movements between components 1 and 2, so that the risk of a canting of the sealing body 7 in the gap 3 is reduced.

In the embodiment of FIGS. 1 and 2, the profile of the band 18 used to produce the sealing body 7 has between two end sections 15 a U-shaped center section 16 that surrounds or forms the above mentioned hollow profile 13 and also has the support zone 11. The end sections 15 are rounded towards the outside and carry the contact zones 8.

In a simpler embodiment according to FIG. 3, the band 18 used to produce the sealing body 7 may have a C-shaped profile.

It is clear that the sealing body 7 basically may have any desired profile, as long as the desired resilience is ensured for the contact zones 8. FIG. 4 therefore shows a sealing body 7 with an unsymmetrical profile as an example. While in the embodiments of FIGS. 1 to 4 the contact zones 8 are always formed directly on the bank 18 from which the sealing body 7 is produced, the band 18 in the embodiment according to FIG. 5 carries contact bodies 17 on which the contact zones 8 are formed. The contact bodies 17, for example, can be welded or soldered to the band 18 of the sealing body 7. This makes it possible to optimize the selection of materials and/or the shape of the band 18 and of the contact bodies 17 in relation to the respective function while the contact bodies 17 is optimized with respect to the sealing function and movability of the contact zone 8 along the sealing surface 9 of the first component 1, the band 18 may be designed with respect to the desired spring preload.

List of Reference Numerals

1 first component

2 second component

3 gap

4 first space

5 second space

6 gap seal

7 sealing body

8 contact zone

9 sealing surface

10 step

11 support zone

12 gap plane

13 hollow profile

14 profile opening

15 end section

16 center section

17 contact body

18 band

1. Gap seal for sealing a gap (3) between two adjacent components (1,2), in particular in turbo machines, with a sealing body (7) from a band (18) that has a cross-section bent in such a way that two contact zones (8) formed on it abut with a preload against two facing sealing surfaces (9) of the components (1,2) and deflect resiliently when the distance between the sealing surfaces (9) is changed, and that a support zone (11) formed between the contact zones (8) is supported vertically to the spring movement on a step (10) formed on one of the components (2) and projects from the latter's sealing surface (9) towards the sealing surface (9) of the other component (1).

2. Gap seal according to claim 1,
characterized in that
the gap (3) connects two spaces (4,5) with different pressures, whereby the sealing body (7) is supported on that side of the step (10) that faces the space (4) with the higher pressure.

3. Gap seal according to claim 2,
characterized in that
the sealing body (7) has a hollow profile (13) that is open on one side of its cross-section, whereby a profile opening (14) faces the space (4) with the higher pressure.

4. Gap seal according to one of claims 1 to 3,
characterized in that
the band (18) consists of correspondingly bent spring steel.

5. Gap seal according to one of claims 1 to 4,
characterized in that
the two sealing surfaces (9) of the components (1,2) are constructed level and extend parallel to each other, and that the two contact zones (8) are located on a straight line that is vertical to the sealing surfaces (9).

6. Gap seal according to one of claims 1 to 5,
characterized in that
the band (18) has a C-shaped profile.

7. Gap seal according to one of claims 1 to 5,
characterized in that
the profile of the band (18) has a U-shaped center section (18) with the support zone (11) between two end sections (15), whereby the end sections (15) are bent outward in a rounded way and are provided with the contact zones (8).

8. Gap seal according to one of claims 1 to 7,
characterized in that
contact bodies (17) provided with contact zones (8) are formed on the band (18).

9. Gap seal according to one of claims 1 to 8,
characterized in that
the step (10) projects from the associated sealing surface (9) to such an extent that the shaped bend of the sealing body (7) also remains in the elastic range when step (10), because of a corresponding relative movement of the components (1,2), comes to abut against the opposite sealing surface (9) or on the opposite component (1).

10. Gap seal according to one of claims 1 to 9,
characterized in that
at least one of the components (1,2) is a guide vane or a rotor vane or a heat shield element of a turbine or of a compressor.
